(19) United States
(12) Patent Application Publication
(10) Pub. No.: US 2016/0196511 A1
(43) Pub. Date: Jul. 7, 2016

(54) METHODS AND APPARATUS FOR ANALYSIS OF EMPLOYEE ENGAGEMENT AND CONTRIBUTION IN AN ORGANIZATION

(71) Applicant: Saama Technologies Inc., Campbell, CA (US)

(72) Inventors: Vidya Sagar Anisingaraju, San Jose, CA (US); Suresh Katta, Monte Sereno, CA (US)

(21) Appl. No.: 14/987,573

(22) Filed: Jan. 4, 2016

Related U.S. Application Data
(63) Continuation-in-part of application No. 14/971,885, filed on Dec. 16, 2015.
(60) Provisional application No. 62/124,799, filed on Jan. 5, 2015.
(60) Provisional application No. 62/124,815, filed on Jan. 5, 2015.

(51) Int. Cl. G06Q 10/06; G06Q 50/00; G06F 17/30

(52) U.S. Cl. CPC G06Q 10/063; G06F 17/30401; G06Q 50/01

(57) ABSTRACT

Methods and apparatus for modeling, using a data science approach, the propensity of employee turn-over and the level of engagement of employees. Both unstructured and structured data from internal and external sources are included in the analysis to determine the level of satisfaction and contribution by employees. What-if analysis permits assessment of the impact on satisfaction, contribution and/or budget for various what-if scenarios, permitting management to take the most effective action to drive retention and/or employee contribution goals.

### CROSS REFERENCE TO RELATED APPLICATIONS

The present application claims priority under 35 USC 119(e) to a commonly-owned provisional application entitled “Saama Fluid Analytics Engine (SFAE)”, Application No. 62/124,799, filed on Jan. 5, 2015, and also to a commonly-owned provisional application entitled “Employee Engagement with Propensity Modeling”, Application No. 62/124,815, filed on Jan. 5, 2015, both of which are incorporated herein by reference for all purposes.

The present application also is a continuation-in-part and claims priority to a commonly-owned application entitled “Abstractly Implemented Data Analysis Systems and Methods Therefor”, application Ser. No. 14/971,885, filed on Dec. 16, 2015, which is incorporated herein by reference for all purposes.

### BACKGROUND OF THE INVENTION

Business intelligence (BI) is of utmost importance to businesses. Business intelligence involves performing data analytics to answer questions of interest to the business. An example question may be “What is my sales number for this quarter for a certain region.” Another question may be “From available data, who are the customers who may likely be defecting to a competitor.” In performing data analytics-based business intelligence (DA-BI), it is necessary to gather data from a variety of sources, organize the data, analyze the data, and present the analytics result in a manner that makes sense to the user.

There are existing software applications for performing DA-BI currently These applications permit the acquisition of data, the organization of stored data, the application of business rules to perform the analytics, and the presentation of the analytics result. In the past, such applications require the use of an expert system integrator company or highly skilled personnel in the IT department (often a luxury that only the largest companies can afford) since these tools require custom coding, custom configuration and heavy customization.

The explosion in the volume of data in the last few years means that the customer now has more data and more variety of data formats to work with. At the same time, customers are demanding more in-depth answers from the available data. This increase in data volume and data formats, as well as the increased need of customers, has created a need to update or change many existing business intelligence applications. However, due to the customized hard coding nature of existing BI-applications, many businesses have not been willing or simply do not have the money and/or time to commit to updating their existing BI system or purchasing a new BI system.

Furthermore, new technologies are now available for data storage, data acquisition, data analysis, and presentation. Big data or cloud computing (whether open-source or proprietary) are some examples of such technologies. Some of these technologies have not yet been widely adopted by the BI industry. Being new, the level of expertise required to make use of these technologies is fairly high since there are fewer people familiar with these technologies. This trend drives up the cost of implementing new BI systems or updating existing BI systems for customers, particularly if the customers desire to make use of the new technologies.

In view of the foregoing, there is a need for a new approach to create and/or update data analytics applications for customers.

### SUMMARY OF THE INVENTION

The invention relates, in one embodiment, to a computer-implemented method for obtaining employee insights from aggregated data pertaining to an organization, the aggregated data including at least unstructured data. The method includes processing the aggregated data using natural language processing to generate a set of attributes, the set of attributes being associated with at least one of satisfaction and contribution. The method also includes processing the aggregated data using natural language processing to generate a set of contributors, the set of contributors being related to the set of attributes. The method additionally includes analyzing, using the of attributes and the set of contributors, to generate a set of insights, the set of insights including at least one of a satisfaction level and a contribution level associated with an evaluation target entity (ETE) of the organization, the ETE being one or more employees of the organization.

In another embodiment, the invention relates to a computer-implemented method for analyzing contribution and satisfaction data pertaining to employees of an organization, the analyzing being responsive to a query. The method includes aggregating unstructured data from various data sources to form aggregated data. The method further includes processing the aggregated data using natural language processing to generate a set of attributes, the set of attributes represent at least one of a set of topics, a set of sentiments, and a set of emotions. The method additionally includes processing the set of attributes to generate a set of insights, the set of insights representing at least one of a level of satisfaction and a level of contribution associated with an evaluation target entity (ETE) of the organization, the ETE being one or more employees of the organization.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 shows, in accordance with an embodiment of the invention, a typical existing business intelligence (BI) analytics system;

FIG. 2 shows, in accordance with an embodiment of the invention, the conceptual organization of the improved abstractly-implemented data analysis system (AI-DAS);

FIG. 3 shows, in accordance with an embodiment of the present invention, the details of one implementation of the abstractly-implemented data analysis system (AI-DAS) system;

FIG. 4 shows a system architecture of an example AI-DAS implementation;

FIG. 5 shows, in accordance with an embodiment of the invention, an example workflow employing the runtime engine in order to perform business intelligence analysis;

FIG. 6 shows some of the technologies involved in implementing the data sourcing, data acquisition, data management, data analysis, data staging, and data extraction;

FIG. 7 shows some of the technologies employed in implementing each of the technology stacks in the AI-DAS system;

FIG. 8 shows, in accordance with an embodiment of the invention, an example employee engagement matrix;

FIG. 9 shows, in accordance with an embodiment of the invention, a conceptual representation of employee contribution scoring;

FIG. 10 shows, in accordance with an embodiment of the invention, a conceptual representation of employee satisfaction scoring;

FIG. 11 shows, in accordance with an embodiment of the invention, a conceptual correlation between two satisfaction attributes;

FIG. 12 shows, in accordance with an embodiment of the invention, a conceptual correlation between another two satisfaction attributes; and

FIG. 13 shows, in accordance with an embodiment of the invention, a data flow representation of the employee satisfaction and contribution analysis technique.

### DETAILED DESCRIPTION OF VARIOUS EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Embodiments of the invention relate to methods and apparatuses for creating data analysis (DA) systems for generating insights (also known as results) from a plurality of data sources without requiring the designer/implementer of the DA system or the user to understand complicated technology details such as for example coding, big data technology or high-end business analytics algorithms.

In one or more embodiments, there exists an abstraction layer, known as a metadata layer, that contains metadata construct pertaining to data definition and design definition for subcomponents of the DA system. The technology details (e.g., what technology is employed to implement a particular subcomponent or to facilitate communication/storage) is abstracted and hidden from the designer/implementer and/or the user. The subcomponents communicate via APIs (application programming interface) to facilitate plug-and-play extensibility and replacement.

The metadata construct (which may be a file or library or collection of files/libraries) contains information on the data definition (what data to expect; the format of the data; etc.) as well as the design definition (what to do with the receive data; how to store, organize, analyze, and/or output the data, etc.) as well as the data flow among the subcomponents. Preferably, the metadata construct is created in advance during design time. At execution time, the execution engine receives the BI query from a user, reads the data in a metadata construct that corresponds to that BI query and executes the BI query using data in the metadata construct to enable the subcomponents to retrieve and analyze data as well as output the BI insight.

In one or more embodiments, a user interface, which may be graphical, is employed to create the metadata construct. In one or more embodiments, the metadata construct is an XML, file. The metadata construct represents a standardized manner to communicate with subcomponents of the BI system and contains instructions on how those subcomponents are to act, alone and in coordination with one another, to transform the data from the various data sources into an analysis result such as a business insight. Since the metadata construct is an abstraction of the underlying technology, embodiments of the invention allow implementers to create an end-to-end BI application that takes in a BI query and automatically provide the BI insight simply by populating or creating content in the appropriate metadata construct (as well as some light customization for data output format if desired).

In this manner, an end-to-end DA application (such as a business intelligence application) can be implemented without requiring the time consuming hard coding and expensive/scarce knowledge regarding the underlying technologies/algorithms. Furthermore, by allowing subcomponents to be implemented in a plug-and-play manner via APIs, it is possible to re-use or leverage existing analytics tools or parts thereof (such as an existing analysis module) by simply providing an appropriate API for the module and generating the data definition and design definition for it in the metadata construct. This is a huge advantage to customers who may have already invested substantially in existing data analysis infrastructure.

These and other advantages of embodiments of the present invention will be better understood with reference to the figures and discussions that follow.

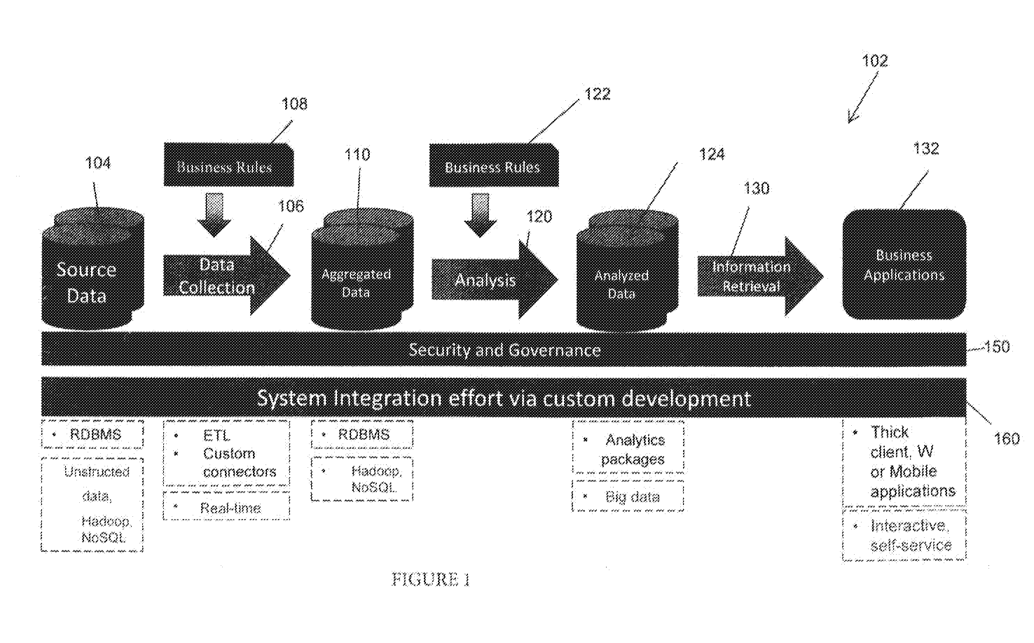

FIG. 1 shows, in accordance with an embodiment of the invention, a typical existing business intelligence (BI) analytics system. In this application, a business intelligence system is used as an example of a data analytics system but it should not be a limitation and the discussion applies to data analytics systems in general.

A BI system 102 receives data from a variety of data sources 104 in a variety of formats. These data sources may include the corporate transactional systems (such as sales or accounting or customer relations), syndicated data (such as from 3rd party), web-based data (such as social media) and streaming data. The data may be stored in a relational database (RDBM) or in big data-related storage facilities (e.g., Hadoop, NoSQL). With regard to format, the data may be in any format including unstructured, structured, streaming, etc.

Data collection 106 pertains to activities required to acquire the data from the data sources 104. Data acquisition may employ ETL (Extract, Transform, Load) technologies or may employ custom connectors to the individual data sources 102 for example. The data collection may happen in batches or in real time.

During data collection, business rules 108 may apply to pre-filter and/or pre-process the data. For example, some syndicated data may be in a specific format to suit the needs of a particular system unrelated to BI (such as reimbursement data from the reimbursement database of insurance companies, which data may include short-hand alphanumeric coding for common procedures and/or medication) and these formats may need to be converted for more efficient utilization by the analysis component later.

The data collected is then stored in an aggregated data source 110 for ready use by the analysis module. The aggregated data may be stored in a relational database (RDBM) or in big data-related storage facilities (e.g., Hadoop, NoSQL), with its formatting pre-processed to some degree (if desired) to conform to the data format requirement of the analysis component.

The analysis component analyzes (120) the data using business rules 122 and stores the BI insight in analyzed data store 124. The analysis may employ some custom analytics packages or may employ big data analysis techniques for example. At some point in time, the user may desire to know the BI insight and thus information retrieval (130) is performed to obtain the BI insight from the analyzed data store 124 and to present the BI insight to business applications 132. These presentation methods may be self-service or interactive (such as through a webpage that allows the user to sort and organize the data in various ways). The presentation medium may be a thick client, a web or mobile application running on a desktop, laptop, or mobile device for example.

Underlying the above activities is a security and governance subsystem 150 that handles house-keeping and system-related tasks such as scheduling jobs, data access authorization, user access authorization, auditing, logging, etc.

In the past, the implementation of BI system 102 typically involves hard-coding the components, creating custom code to enable the components of FIG. 1 to interoperate and produce the desired BI insight. The system integration effort and custom development (160) require a substantial investment of time and effort during the development, integration, and deployment stages. Because of the rapidly changing technology landscape, a typical company often does not have sufficient IT expertise in-house to build, maintain and/or deploy a BI system if that company desires to utilize the latest technology. Instead, the work is contracted out to integrator firms with special expertise at great cost in each of the development, maintenance, deployment, and upgrade phases.

The hard coding approach makes it difficult and/or expensive to upgrade when new BI insight needs arise and/or when improved technology is available for the tasks of data acquisition, data analysis, and/or data presentation. It also makes it difficult to re-use legacy subcomponents that the business may have already invested in the past. This is mainly because of both the cost/time delay involved in re-coding a BI system and the predictable scarcity of knowledgeable experts when new technologies first arrive.

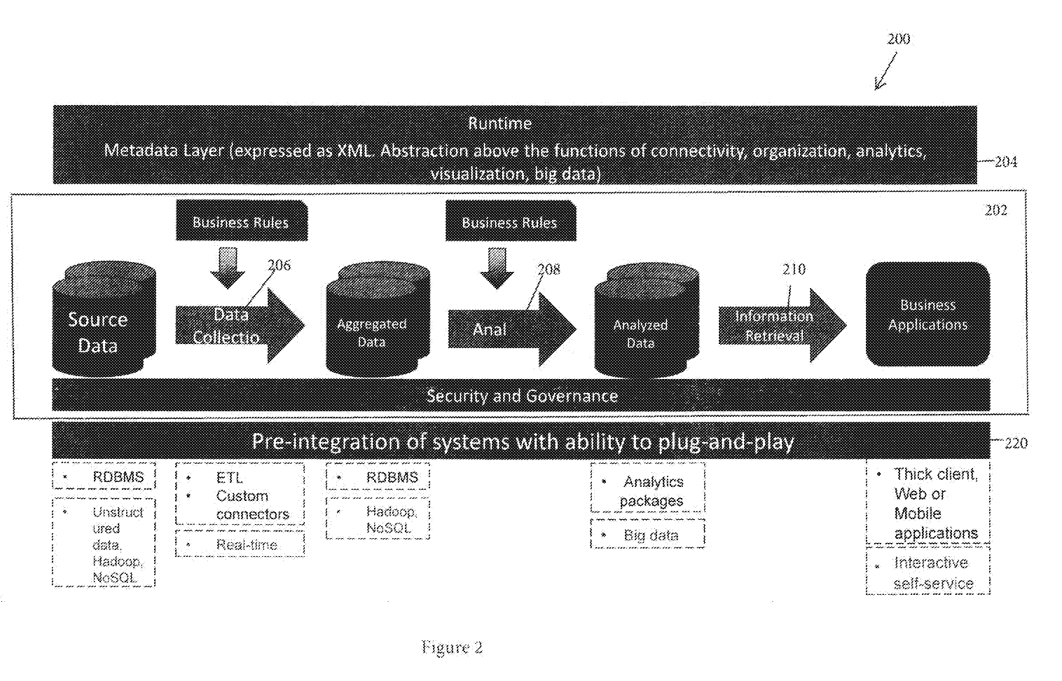

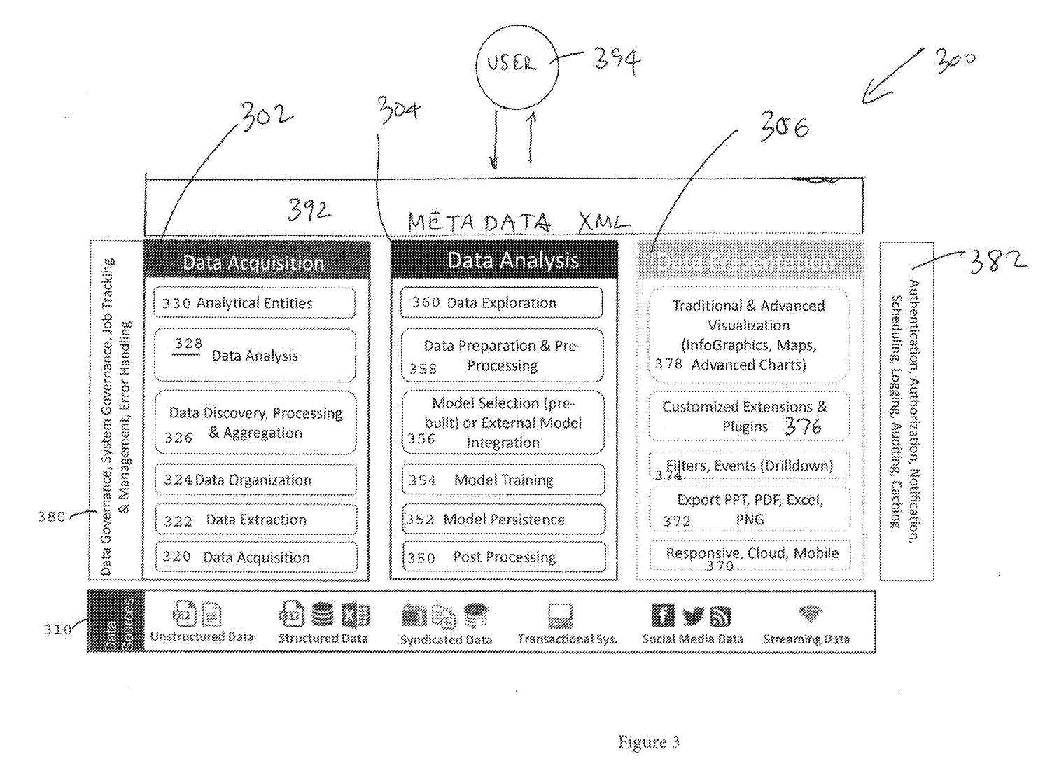

FIG. 2 shows, in accordance with an embodiment of the invention, the conceptual organization of the improved abstractly-implemented data analysis system (AI-DAS). The conceptual tasks that need to be performed in box 202 are analogous to those discussed in connection with FIG. 1. However, embodiments of the invention pre-integrate (220) the subcomponents (to be discussed later in FIG. 3 and later figures) with plug-and-play capability in order to facilitate their upgradeability and extensibility.

More importantly, there exists an abstraction layer, known as a metadata layer 204. The metadata may be implemented by a file or library or a collection of files or libraries and contains data pertaining to the data flow among the subcomponents of components implementing the three tasks of BI system 200 (data collection 206, data analysis 208, and analysis result retrieval/presentation 210). The metadata may also include information about data definition and design definition for each of the subcomponents. Generally speaking, data definition pertains to the location where the data comes from and where it is to be outputted, the format of the data, and the like. Design definition generally pertains to the operation in each subcomponent including for example what to do with the inputted data, how to store, organize, analyze, output the data, etc.

The metadata 204 is designed during design time in order to define the operation of the subcomponents and the data flow among the subcomponents, and by extension, the operation of the resulting BI system for a particular type of query. During design time, the designer/implementer is shielded or isolated from the technology details of the subcomponents. The designer/implementer task becomes one of populating the metadata construct with sufficient information to allow each subcomponent to know what data to expect and to output, and how each subcomponent is to behave during execution. In an embodiment, a graphical user interface is provided to assist in the task of filling out the data fields of the metadata. Because the implementer/designer of the BI system only needs to work at the high level of abstraction of the metadata layer, expensive skilled knowledge regarding the newest technology is not required. Further, because the system can be easily reconfigured (simply by creating another metadata) to handle different analysis tasks or accommodate different/substitute subcomponents, re-use of many of the subcomponents is promoted.

At execution time, the BI query from the user is intercepted and a metadata construct (file, library, or set of files/libraries) appropriate to that BI query is retrieved. The execution engine then reads and interprets the data in the metadata in order to know how to utilize the subcomponents to perform tasks to arrive at the BI insight requested by the BI query. Again, the user does not need know the details of the underlying technologies or even the presence/structure of the metadata itself. As long as the user can input a BI query that can be parsed and understood by the BI system, the BI system will automatically select the appropriate metadata construct and will automatically carry out the required tasks using data from the metadata construct and the subcomponents of the BI system.

FIG. 3 shows, in accordance with an embodiment of the present invention, the details of one implementation of the abstractly-implemented data analysis system (AI-DAS) system 300. AI-DAS 300 includes three main components: Data acquisition, data analysis, and data presentation.

Data acquisition 302 relates to getting the data, organizing the data, extracting the data, storing the data. As shown in box 310, the various data sources include unstructured data (e.g., freeform data such as the text entered by patient comments or doctor/nurse comments), structured data such as data enter into fields of a form, syndicated data such as data purchased or received from third parties, transactional system data such as data directly obtained from the ERP system or the enterprise data store of the company, social media data such as data from Facebook, Twitter, Instagram, and the like. The data may be received in batches or may be streaming data. These are only examples of data sources that may be employed for analysis by the AI-DAS 300.

Within data acquisition component 302, there exists a plurality of subcomponents shown as data acquisition-related subcomponents 320-330. Subcomponent 320 pertains to the task of data acquisition, which relates to how the data is acquired from various sources 310.

Subcomponent 322 relates to data extraction, which contains the logic to extract the data sources 310. Subcomponent 324 pertains to data organization, which contains the logic to organize the extracted data. Subcomponent 326 pertains to certain pre-processing of the data. For example, the extracted data is discovered (such as using parsing or artificial intelligence) processed (such as mapping) and aggregated. Splitting and merging of various data items may also be done.

Subcomponent 328 pertain to additional higher level processing of the data, if desired. Subcomponent 330 pertains to grouping data sources into a transactional unit that can be processed as a single entity. For example, the total number of data sources may comprise hundreds of data sources available. However, for a particular BI query, only certain data resources are used. These can be grouped together in a single analytical entity for ease of administration.

Data analysis component 304 relates to analyzing the data and extracting meaning from the aggregated data that is output by data acquisition component 302. Within data analysis component 304, there exists a plurality of subcomponents shown as data analysis-related subcomponents 350-360. Subcomponent 360 relates to data exploration since at this stage, it may not be known what the data contains. Artificial intelligence or pattern matching or keywords may be employed to look for meaning in the data. The data can be prepared and preprocessed in 358 to convert the data into a format for use by the algorithm.

The three subcomponents 352, 354, and 356 represent the machine learning approach that is employed for this example of FIG. 3. In subcomponent 356, the model is selected which may be prebuilt or an external model may be integrated. In subcomponent 354, the model is trained and once the model is selected 356 and trained in 354, the model may be persisted 352 to process the incoming data. Post-processing 350 relates to preparing the data for presentation, which occurs in data presentation component 306.

Data presentation subcomponent 306 relates to how to present the data to the user. The data may be presented using traditional and advanced visualization methods (378) such as infographics, maps, and advanced charts. Legacy presentation tools may also be employed via standard or customized extensions and plug-ins 376. Tool may be provided for the user to filter and to drill down the data, essentially allowing the user to explore the result in 374. The data may also be exported into a desired data format for later use. This is shown 372 wherein the example the formats are PowerPoint, PDF, Excel, PNG. The presentation mechanism can be interactive or static, and presentation data can be sent via the cloud and/or internal network to a laptop, desktop, or mobile device (370).

Subcomponent 380 relates to data governance, system governance, job tracking and management, and error handling. These are tasks related to managing the hardware and software resources to perform the analysis. Subcomponent 382 relates to control of data access and job execution and user access. Thus, there is shown authentication, authorization, notification, scheduling of jobs. Logging, auditing, and intelligent caching of data to improve execution speed are also shown in 382.

A metadata construct 392 is shown interposing between the user 394 and the components/subcomponents of the AI-DAS 300. As mentioned, this metadata contains the higher level abstraction of the subcomponents and allow the AI-DAS to be implemented without knowing the complex underlying technology details.

All the subcomponents shown in each of the data acquisition, data analysis, and data presentation components can be either off-the-shelf, custom created, open-source, or legacy subcomponents. For plug-and-play implementation, these subcomponents preferably communicate using the API model. These subcomponents can be implemented on an internal network, in the cloud using a cloud-based computing paradigm (such as through Amazon Web Services or Google Web), or a mixture thereof. Generically speaking, these are referred to herein as computer resource.

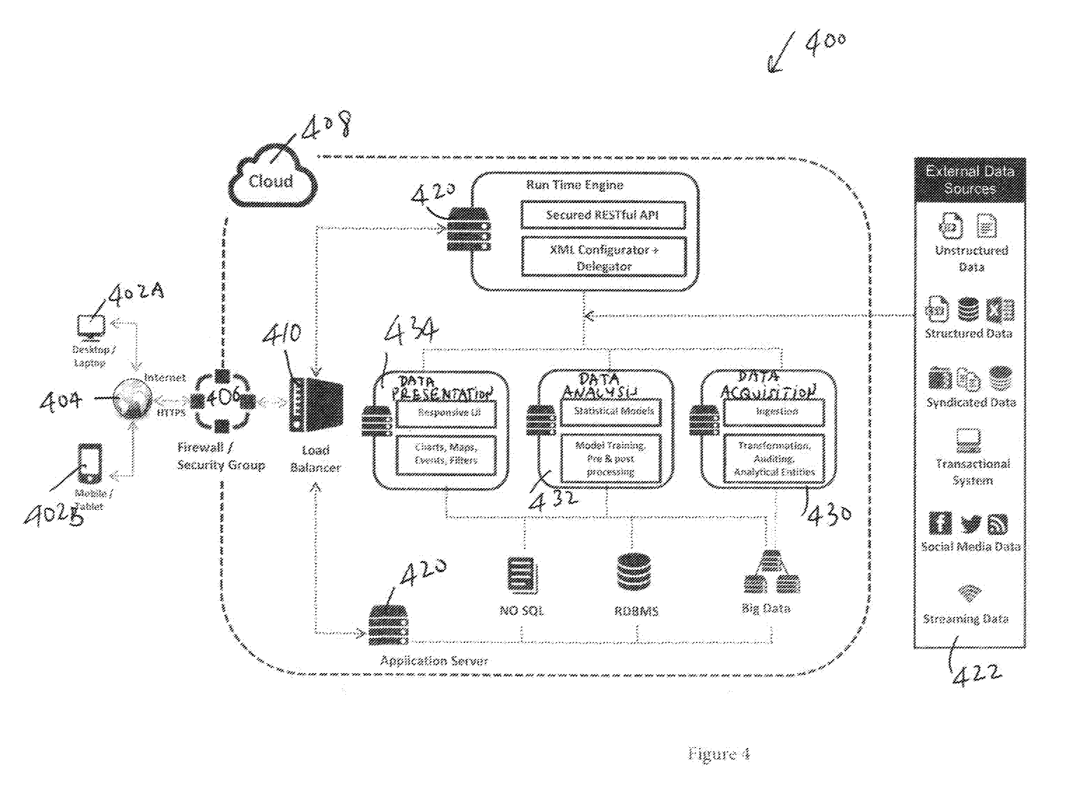

FIG. 4 shows a system architecture of an example AI-DAS implementation, including user interface devices 402A and 402B (desktop/laptop and mobile devices respectively). These devices can access the AI-DAS system 400 via in the Internet 404 using for example the HTTPS protocol. Firewall/security group 406 and cloud 408 show that components/subcomponents and data storage employed to implement the AI-DAS may reside in the cloud or may reside behind the firewall within a company or can be both.

The AI-DAS operation is governed by a load balancer 410 which load balances multiple copies of the AI-DAS runtime engine 420. For ease of illustration, the multiple implementations of the AI-DAS runtime engine 420 are shown at both the top and the bottom of FIG. 4. At the top of FIG. 4, these multiple instantiations of the AI-DAS runtime engine interacts with the API (such as Secure RESTful API) that governs the communication between subcomponents in the data acquisition component, the data analysis component, and the data presentation component. The AI-DAS runtime engine also reads the metadata (implemented as an XML in the example) and interpret the XML then delegates the tasks specified by the XML to various subcomponents in the data acquisition, data analysis, and data presentation subcomponents.

Data is received from external data sources 422 and is processed via data acquisition subcomponent 430, data analysis subcomponent 432, and data presentation subcomponent 434. The data is processed by data acquisition subcomponent 422 via ingestion module and transformation, auditing, analytical entities. The aggregated and analyzed data is then stored in the appropriate data store (such as Hadoop big data store), relational database RDBMS, or noSQL data store.

The data analysis subcomponent 432 represents the intelligence component and includes therein statistical models and modules related to model training, pre- and post-processing. The data presentation subcomponent 434 includes the various responsive (interactive) user interfaces and may include traditional presentation tools such as charts, maps, events, filters. As shown in FIG. 4, there may be multiple instantiations of each of the components/subcomponents in addition to different instantiations of multiple runtime engines, all of which can be load balanced to horizontally scale the analytics system to accommodate any volume of analytics jobs.

Generally speaking, there are the two separate phases of building and delivering an AI-DAS end-to-end application. One of the requirements is that the subcomponents employ APIs, allowing them to interoperate using an API model and to receive instructions from the execution engine as the execution engine interprets the metadata. Thus, during design time, a designer/implementer may create the metadata XML that includes the data definition and design definition for the subcomponents. Once the design phase is completed, the system is deployed and ready to produce analysis result during execution time.

During execution time (which occurs when a user inputs a query), the metadata XML is selected for the query, interpreted and executed by the AI-DAS engine, which metadata specifies how each subcomponent would behave based on the parameters specified in the metadata. The metadata also specifies the format of the data that the subcomponents exchange among each another, as well as the overall data flow from data intake from multiple data sources to the presentation of the analytic results to the user interface devices.

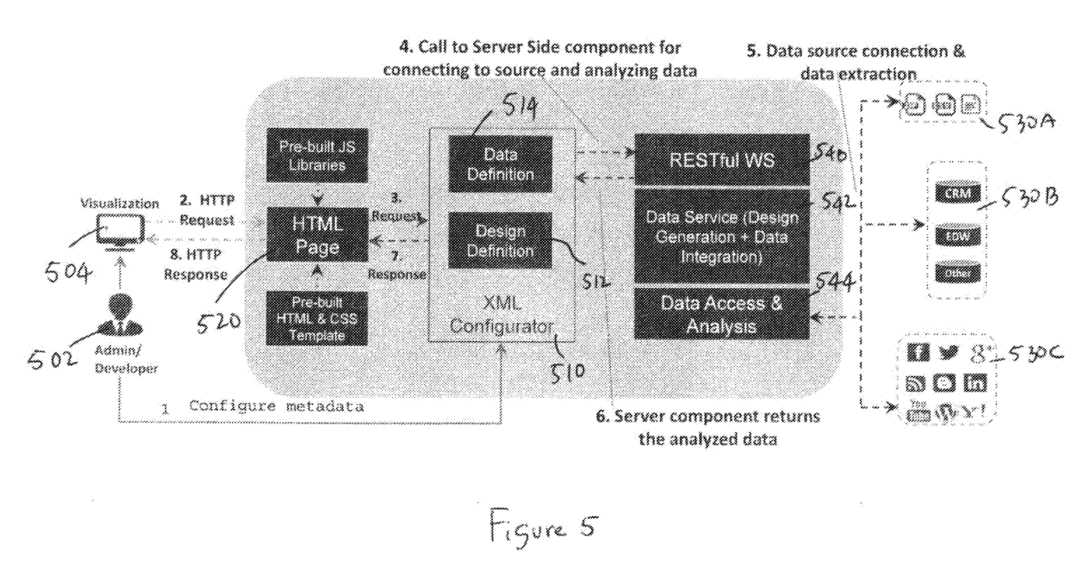

FIG. 5 shows, in accordance with an embodiment of the invention, an example workflow employing the runtime engine in order to perform business intelligence analysis. During design time, administrative/developer 502 employs UI device (which may be for example a laptop or desktop computer) 504 to configure the metadata (such as the XML). This is shown as step 1 of FIG. 5. Preferably, a graphical user interface is employed to simplify the task of populating the metadata fields. At this time, any custom HTML templates and custom javascript can also be created to format the output if desired.

With respect to the metadata XML, the admin/developer 502 may define the data. That is the admin/developer may specify where the data comes from and the type of data that is inputted (e.g., free-form, stream, structured, and the like). The admin/developer 502 may also specify the design definition, that is how the data is used in the application. The design definition defines the goal of the data analysis. For example, one goal may be to perform sentiment analysis on conversation data about nurses. Another goal may be to discover the top three hot topics in the unstructured data that is received. Another goal may be to import certain columns in a relational database and run it through a certain model to identify patients who are not satisfied.

The design definition can also specify the manner in which data is outputted. Examples of such specification include the format and the devices and/or data presentation technologies involved. These are shown in 510, 512, and 514 of FIG. 5.

Then during execution time the user may use a UI device to issue a HTTP request (step 2) that is received by the HTML page 520. The HTML page 520 parses the request then issues another request (step 3) to acquire the appropriate associated metadata XML that contains the data definition and the design definition relevant to the instant query.

With this data definition and design definition in the XML, the AI-DAS engine then makes a call to the server-side component for connecting to resources to obtain data and to analyze data. Note that these data sources and the manner in which the data is analyzed are specified by the XML in the data definition and design definition 514 and 512. This is step 4.

In step 5, the data source connections are selected to connect to the appropriate data sources 530A, 530B, and 530C to obtain data for analysis. The analysis is performed by the server subcomponent that employs, in the example of FIG. 5, the RESTful web service 540. Analysis includes performing data service (design generation and data integration) as well as data access and analysis (542 and 544) in accordance with the definition in the XML.

Once data analysis is completed by the AI-DAS server, the server component returns the analyzed data (step 6) and the response (step 7) is provided to the HTML page. The response may be formatted in accordance with the definition in the XML page. The response is then returned to the UI device 504 for viewing by the user and for interaction by the user (step 8)

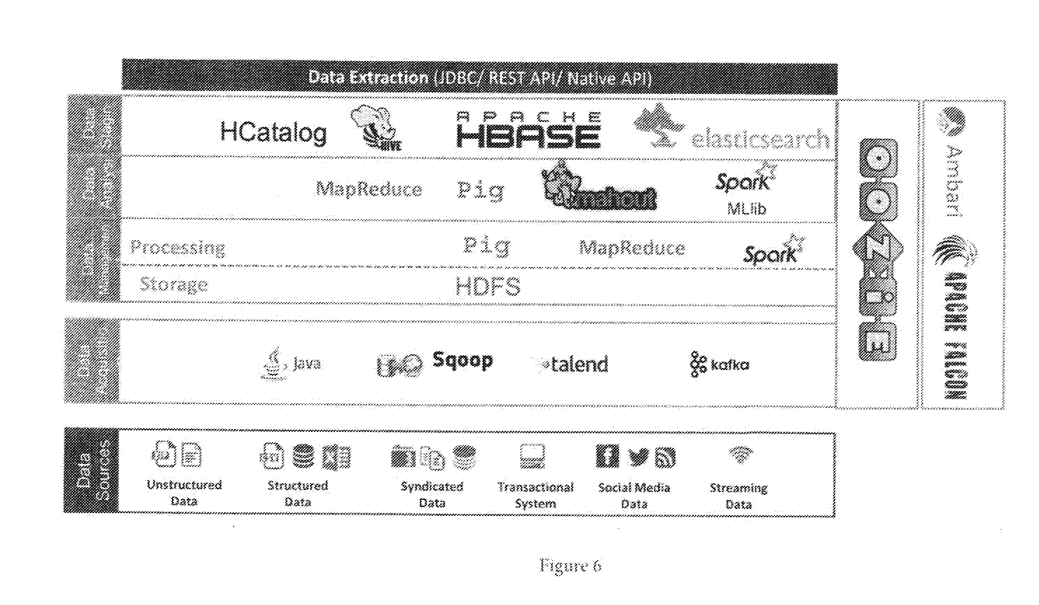

FIG. 6 shows some of the technologies involved in implementing the data sourcing, data acquisition, data management, data analysis, data staging, and data extraction. Some of these technologies are well-known in distributed computing/big data for storage (such as Hadoop) and for analysis (such as MapReduce, Spark, Mahout). Workflow engine may be provided by OOZIE while system administration may be provided by Ambari and Apache Falcon.

It should be noted that the technology details of FIG. 6 are hidden from the design/implementer during design time since the designer/implementer needs only be concerned with the metadata population and any optional HTML/JS customization for data outputting. These technology details are also hidden from the customer/user during execution since the customer/user only needs to issue a query that can be parsed to obtain the associated XML, and the rest of the analysis and underlying details regarding technology are handled transparently.

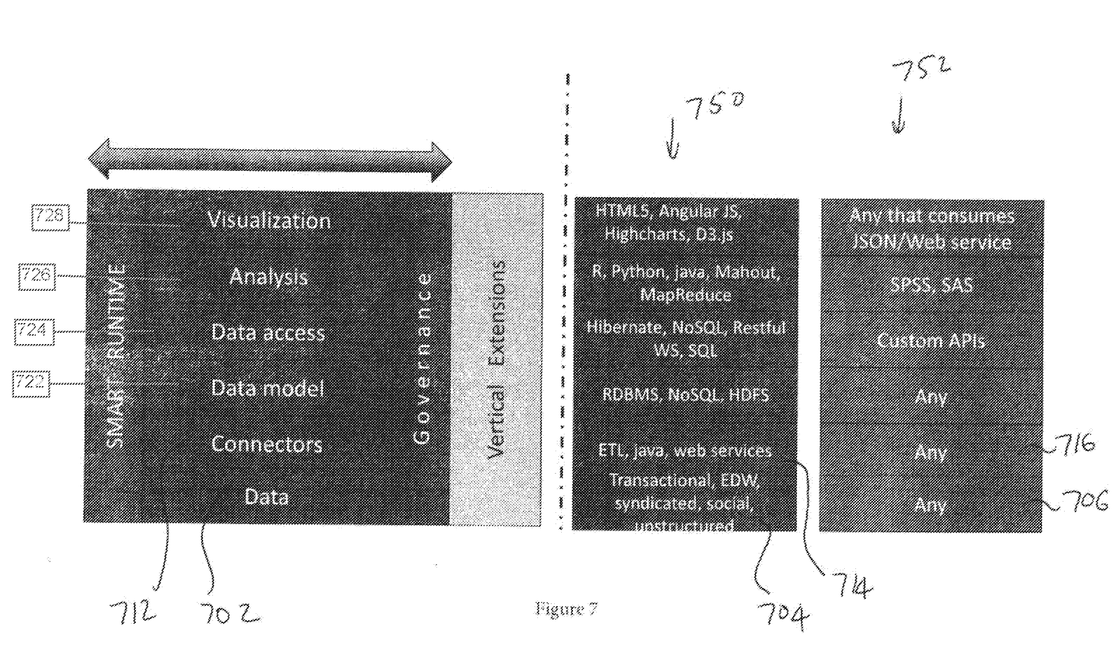

FIG. 7 shows some of the technologies employed in implementing each of the technology stacks in the AI-DAS system. For example, the data layer 702 may be implemented by (704) transactional, enterprise data warehouse (EDW), syndicated, social, and unstructured data. However, any other alternative data source (706) may be employed.

Connectors layer (712) may be implemented by (714) ETL, Java, Web services. However, any appropriate alternative integration connecting technology (716) may also be employed. The same applies to the data model layer 722, data access layer 724, analysis layer 726, and visualization layer 728. For each of these layers, there is a corresponding list of example technologies in the stack 750 as well as in alternatives/integration 752. One important point to note is since the underlying technology is hidden, the layers (such as data, connectors, data model, data access, and the analysis, visualization) may be implemented by any appropriate technology, including legacy technology.

As can be appreciated from the foregoing, embodiments of the invention renders it unnecessary for the designer/implementer to know or to manipulate complex technology in the implementation, maintenance, or upgrade of a data analysis system. The metadata layer abstracts these complex technology details away and provide standardized, easy-to-implement way of specifying how the DAS system should operate to solve any particular analysis problem.

As long as the subcomponents comply with the API model for interoperability, the underlying technology may be interchangeable on a plug-and-play basis. The ease with which the AI-DAS system can be implemented (due to the abstraction of the complex technology details away from the designer/implementer) encourages exploration and renders implementation, maintenance, and upgrade of a data analysis system substantially simpler, faster, and less costly than possible in the current art.

Organizations are always concerned with the need to attract, engage and retain human talent. While an organization may have many employees or groups of employees in many different functions and levels of responsibility, the challenge has always been to identify those with the highest level of contribution to the organization and find ways to retain productive employees, particularly those who make vital contribution to the organization goal and values.

Classifying contributors (for example to identify the level of engagement of employees) and employee satisfaction has always been a difficult exercise. Part of the reason is the imperfect tools available to collect and measure metrics that reflect contribution and satisfaction. Another part of the reason is the lack of data-driven methodologies to scientifically collect, measure, quantify, and improve conditions that lead to increased contribution and satisfaction. Another reason, as will be discussed later herein, is the explosion in the type, velocity, and volume of structured and unstructured data available for analysis.

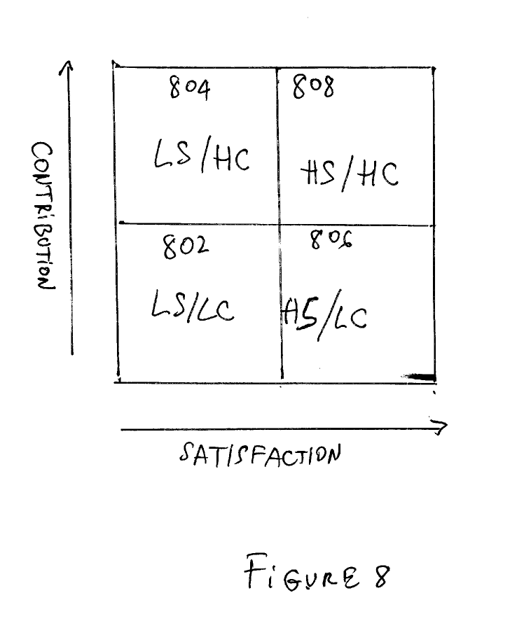

To elaborate, each employee in most organizations can be loosely categorized as belonging to one of four groups in a conceptual employee engagement matrix (800 of FIG. 8): LS/LC (802), LS/HC (804), HS/LC (806), and HS/HC (808).

LS/LC 802 refers to employees who are low in satisfaction and low in contribution. These are the employees who are low contributors to the organization goals and values and who are also not satisfied with working for the organization for various reasons.

LS/HC 804 refers to employees who are low in satisfaction and high in contribution. These are the employees who are high contributors to the organization goals and values but who are not satisfied with working for the organization. These are valuable but at-risk employees that most organizations would like to find ways to retain.

HS/LC 806 refers to employees who are high in satisfaction and low in contribution. These are the employees who are low contributors to the organization goals and values but who are satisfied with working for the organization for various reasons.

HS/HC 808 refers to employees who are high in satisfaction and high in contribution. These are the employees who are high contributors to the organization goals and values and who are also satisfied with working for the organization for various reasons.

Category HS/HC 808 is the category that most organizations seek to maximize. All things being equal, most organizations want to create conditions for which an employee would contribute at a high level to the organization and also would be satisfied working for the organization. If desired, employees in category HS/HC 808 may be further divided into sub-groups to identify those whose contribution is most important to the organization and/or who is most satisfied with working for the organization.

In one or more embodiments of the invention, unstructured data and structured data are collected and analyzed to facilitate the categorization of employees and the identification of high contributors to the organization.

To elaborate, unstructured information represents information that tends not to follow any predefined format. Structured content, on the other hand, stores its data in predefined data fields, with each piece of information in each field clearly informing what the field and the data therein represent.

Information in a tax form is an example of structured content, with the taxpayer's name, address, income, etc. all being associated with appropriate data fields. Forum discussions by public members or blog entries or narrative feedback in a comment form, which may be written in conversational English for example, represent unstructured content wherein there may be no apparent organization to the various pieces of information provided.

Both structured information may unstructured information be obtained from sources that are internal or external to an organization, and may include data from publicly available as well as private data sources.

In recent years, the volume and quantity of unstructured and structured data, both internal and external to the organization, have exploded. More and more data is collected by organizations and third-party sources about various aspect of employee contribution and retention. For example, organizations have largely migrated to digital data keeping for their Human Resources (HR) data, employee survey data, salary surveys, exit interview data, employee feedback data, etc. External unstructured data may include (but not limited to) social media sources such as Glassdoor, Facebook, internal and external blogs, Twitter, LinkedIn, and others.

Syndicated sources where data about various aspect of employee contribution and retention is collected and made available by third parties to interested organizations either for free or for a fee also exist. Data available for syndication may include (but not limited to) employee salary surveys, competitive hiring practices, job portal data, talent resume data, etc. The syndication data may be extracted and/or synthesized and/or derived from internal and external sources, which may include (but not limited to) employee salaries, educational qualifications, employment history, termination details, employee sentiment, data extracted from social media posts, data pertaining employment practices of competitive organizations, etc.

The unstructured and structured data, both internal and external to the organization, may be collected periodically, on a real-time basis, or upon the occurrence of some predefined event, for example.

One of the difficulties in assembling and analyzing unstructured data is the sheer volume and the apparent lack of organization of data therein. The other reason for the difficulties is more subtle. Even if the unstructured data can be collected from the various sources and digitized, unless the proper insight could be obtained from the unstructured data, the collection effort is meaningless.

In the past, organizations have attempted to form committees of human readers to tackle the unstructured information available to assist in its employee engagement and retention goals. Each committee member may be asked to read a subset of the unstructured information from one or more sources and to form an opinion about what has been read. The committee members may then meet and decide on the important issues to be addressed based on the unstructured information read by its various members. However, such approach is inherently unscalable and relies on the fragile human recollection and impression. It is also inherently unreliable and highly subjective.

What is desired are more objective, scalable, and automated systems and methods for obtaining insights from structured and unstructured information from various sources to drive improvement in the employee engagement and retention effort of the organization.

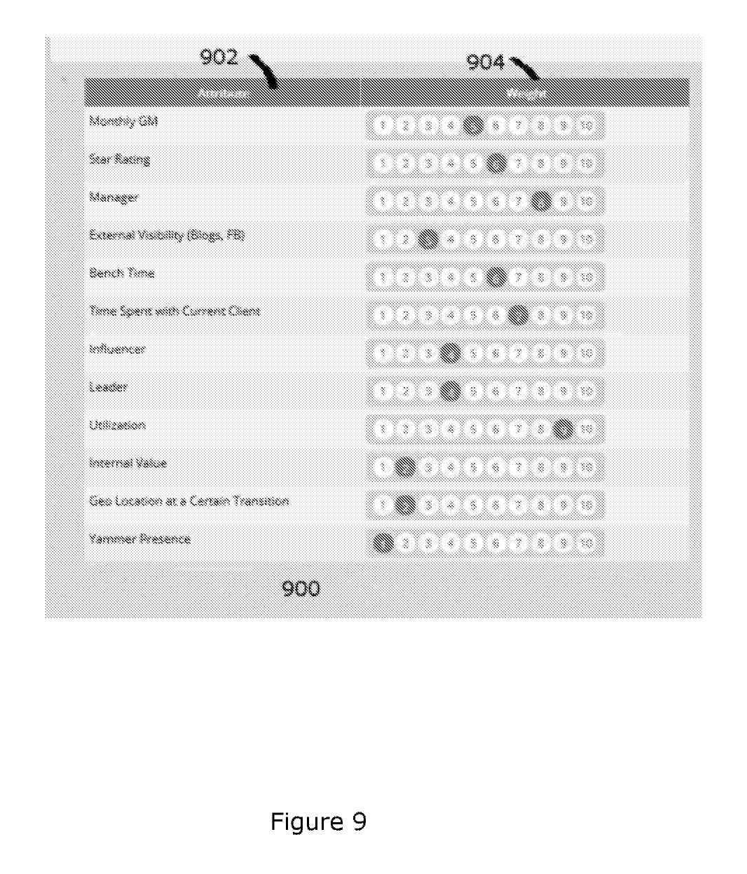

FIG. 9 shows a conceptual framework 900 for classifying the levels of contribution (i.e., engagement) of each evaluation target entity (ETE). An evaluation target entity (ETE) represents a target of the classification (whether contribution or satisfaction classification). An ETE may be, depending on the desired data granularity, a single employee, a group of employees in a related function or in different functional roles, an entire department or even the entire organization.

Internal and external unstructured and structured data is collected and analyzed to derive attributes (902) for contribution by the ETE and to assign a score for each of the attributes. Example attributes include (but not limited to): Monthly GM (attendance at monthly general meetings), star rating (whether star employee status is achieved), manager (contribution in the managerial capacity), and external visibility (Blogs/FB) which relates to the frequency of relevant postings in social media. Example attributes also include bench time (time spent on laboratory tasks), time spent with current clients, influence (ability to influence others), leader (ability to lead others), utilization (how well are the time and the skills of the employees utilized), internal value (the employee value to the organization), geo location at a certain transaction (whether the employee is present during transaction), Yammer presence (the visibility of the employee on collaboration site).

Based on the employee's responsibility or role and/or based on the organization's goal, weights (904) may be attached to these attributes. It should be understood that these weights may be assigned by an appropriately authorized person within the organization or automatically determined by for example algorithm, machine learning or artificial intelligence from the unstructured and structured data. Furthermore, these attributes can be automatically ascertained from the unstructured and structured data, or they may be predefined by the organization or both. The unstructured data, both external and internal, may be processed through natural language processing techniques and/or other techniques to derive data that contributes to the determination of the attributes.

In one or more embodiments, unstructured and structured data are analyzed to determine the evaluation target entity's score for each of the attributes. As an example, internal HR and/or employee evaluation and/or peer review database(s) may be analyzed to automatically determine the ETE's score for a given attribute or multiple attributes. As another example, internal emails and memoranda pertaining to the ETE may be analyzed to obtain one or more scores for one or more of the ETE's attributes. As another example, external syndicated data sources may be analyzed to obtain one or more scores for one or more of the ETE's attributes. In particular, in one or more embodiments, social media data (internal and/or external) may be analyzed, using for example natural language processing, machine learning and/or pattern matching to obtain one or more scores for one or more of the ETE's attributes. A composite score may be calculated based on the sum of the weighted scores of the attributes, in one or more embodiment for each of the ETE. This score in effect represents the contribution (engagement) score for that ETE, e.g., employee or group of employees.

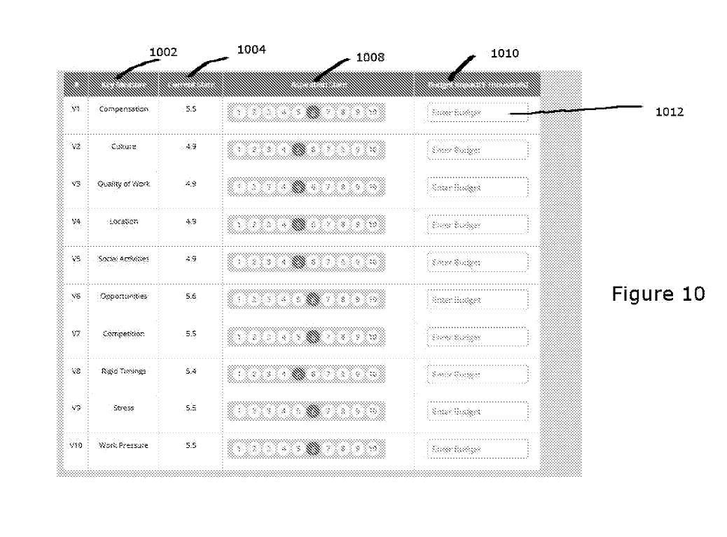

FIG. 10 shows a conceptual framework 1000 for classifying the level of satisfaction of each evaluation target entity (ETE). As discussed, an evaluation target entity (ETE) represents a target of the classification, which may be, depending on the desired data granularity, a single employee, a group of employees in a related function or in different functional roles, an entire department or even the entire organization. Internal and external unstructured and structured data is collected and analyzed to derive attributes for satisfaction for the ETE and/or to assign a score for each of the attributes.

Example attributes (key measures 1002) include (but not limited to): compensation, culture, quality of work, location (distance from home), social activities, opportunities, competition, rigid work times or deadlines (rigid timing), stress, work pressure, and the like. These attributes can be automatically ascertained from the unstructured and structured data, or they may be predefined by the organization or both. The unstructured data, both external and internal, may be processed through natural language processing techniques and/or other techniques to derive data that contributes to the determination of the attributes.

In one or more embodiments, unstructured and structured data are analyzed to determine the evaluation target entity's score 1004 (current state) for each of the attributes. As an example, internal corporate datastores and/or employee evaluation and/or peer review database(s) may be analyzed to automatically determine the ETE's score for one or more scores for one or more of the satisfaction attributes. As another example, internal emails and memoranda by or pertaining to the ETE may be analyzed to obtain one or more scores for one or more of the satisfaction attributes for that ETE. As another example, external syndicated data sources may be analyzed to obtain one or more scores for one or more of the satisfaction attributes for that ETE. In particular, in one or more embodiments, social media data (internal and/or external) may be analyzed, using for example natural language processing, machine learning and/or pattern matching to obtain one or more scores for one or more of the satisfaction attributes for that ETE.

In one or more embodiments, the conceptual framework 1000 may be realized in an UI (user interface) on a computer screen and permits exploration (what-if analysis) for various aspiration states (1008) for the attributes. For example, current state (current score) of the compensation attribute is 5.5 for a particular ETE (such as employee John Smith). In other words, the objective measure for or subjective satisfaction rating by John Smith with regard to compensation is currently assigned a score of 5.5. If the aspiration state is a score of 6 (e.g., by increasing the compensation), embodiments of the invention would, based on for example artificial intelligence, algorithmic, statistical, pattern matching and/or machine learning, determine the budget impact (1010) of such a state change. For example, the change in the score from the current state of 5.5 to an aspiration state of 6 for the compensation attribute may result in a budget of $8,000 being presented in block 1012 under the column budget impact 1010.

This change of the aspiration state may be made by a human operator to determine the impact on employee satisfaction and ultimately his engagement matrix (see FIG. 8). This change in aspiration state may also be driven by data entered into the budget impact (1010) parameter, which would then enable the determination, based on for example artificial intelligence, algorithmic, statistical, pattern matching and/or machine learning, the change in the state (or score) of the associated attribute. For example, a value of $15,000 entered into block 1012 under the column budget impact 1010 may result in a change in the state (score) from the current state of 5.5 to an aspiration state of 7.0. Changes to the satisfaction scores and/or budget impact may result in changes to the engagement matrix of FIG. 8 as employees become more or less satisfied due to the attribute and/or budget impact.

The change in aspiration state for one or more attributes may also be driven by resetting the values in the various quadrants of the engagement matrix. For example, if management desires to increase the number of employees in the HS/LC quadrant (806) by moving some employees from the LS/LC quadrant (802), such change may enable the determination, based on for example artificial intelligence, algorithmic, statistical, pattern matching and/or machine learning, an associated change to one or more of the current state scores and/or budget impacts.

These change would allow management to play what-if analysis and determine the appropriate action(s) to increase employee satisfaction for one or more ETE's to drive retention goals. Similar what-if analysis may be made for the contribution attributes. For example, if the aspiration state for an employee's contribution score is hypothetically changed (e.g., increasing the number of training sessions, by promoting into leadership position, etc.), management may be able ascertain the budget impact and the resultant change in the engagement matrix as the employee's contribution score changes. Conversely, if a number of employees (for example 25) are moved from the LS/LC quadrant 802 to LS/HC quadrant 804 (e.g., in response to a desire from the president of the organization), management may be able to understand what actions need to be taken to increase employee contribution and the budget implications associated therewith.

In one or more embodiments, employee satisfaction (FIG. 10) is correlated with contribution (FIG. 9) to enable the determination for example of which employee(s) merit(s) the organization's attention the most to improve the organization's bottom line. For example, a high contributing employee may be identified based on the analysis discussed in connection with FIG. 9 and correlated with his satisfaction score based on the analysis discussed in connection with FIG. 10. If the high contributing employee is found to be unsatisfied based on the scores (1004) of one or more satisfaction attributes (1002), what-if analysis may be performed to determine the budget impact and satisfaction score impact of increasing, for example, that employee's compensation.

Attributes may be linked together. As an example, an employee may be unsatisfied with compensation but may not be at retention risk since the work location is conveniently close to his home. Conversely, the employee may be satisfied with the compensation but may be at retention risk since the work pressure is too high. These attribute dimensions may be correlated against one another, with break point data (or data pertaining to propensity for leaving after a predefined period of time) determined or assigned for each pairing of attribute scores.

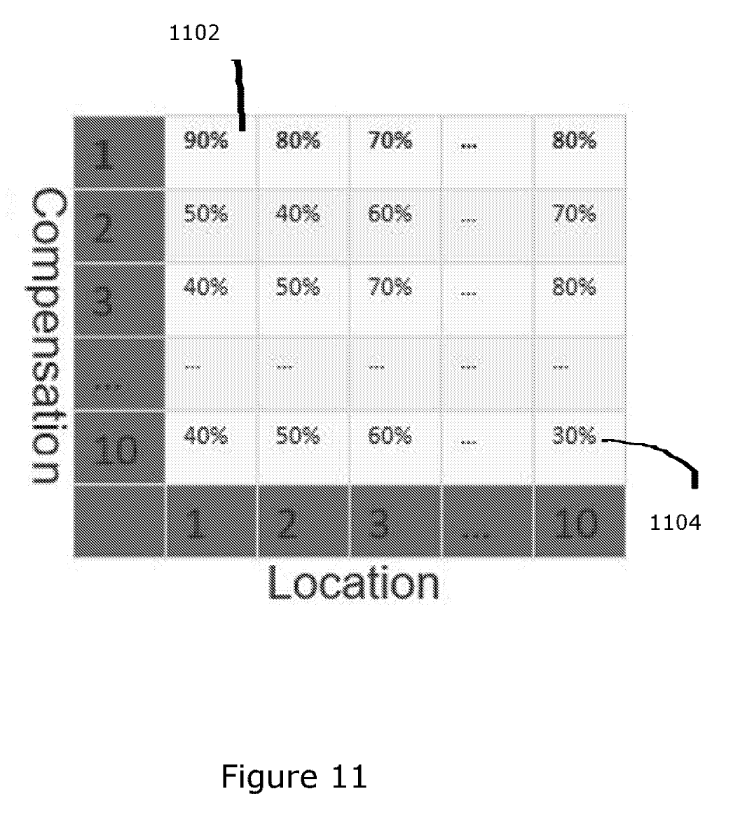

For example, with respect to FIG. 11, a low score of 1 in compensation against low score of 1 in location 1102 would result in a combination that results in a 90% likelihood of departure (1102) within a year for a particular employee. This determination may be made using for example artificial intelligence, algorithmic, statistical, pattern matching and/or machine learning with patterns known from the past. As another example, a high score of 10 in compensation against high score of 10 in location would result in a combination that results in only a 30% likelihood of departure (1104) within a year for that employee. Again, this determination may be made using for example artificial intelligence, algorithmic, statistical, pattern matching and/or machine learning with patterns known from the past.

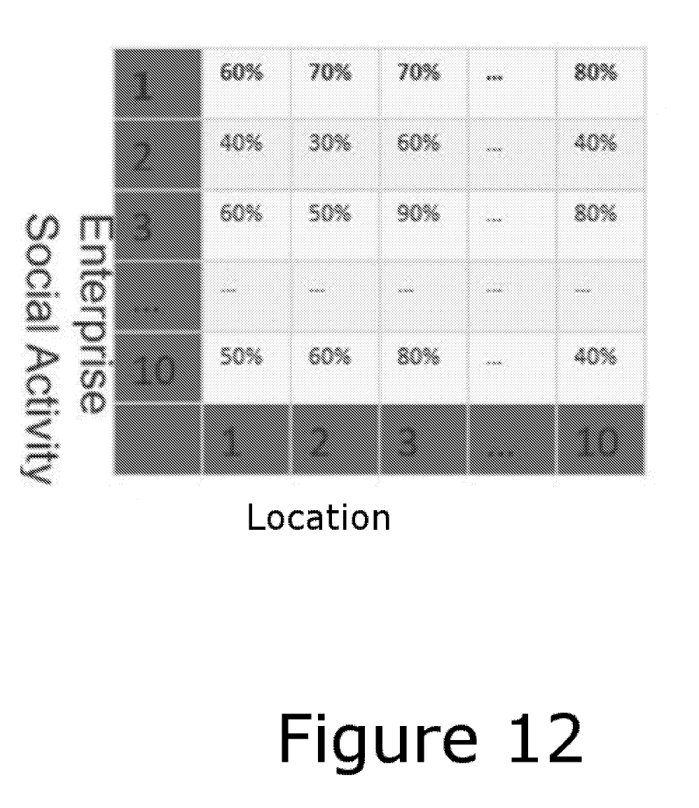

Although FIG. 11 explores only two dimensions (e.g., location vs. compensation), it should be understood that more than two dimensions may be involved (e.g., correlating the 90% score of block 1102 against another attribute dimension such as stress or time into the future). Any set of two or more dimensions (satisfaction attributes) may be analyzed similarly. This shown in the example of FIG. 12 wherein the enterprise social activity scores are correlated with the location scores.

The result may be processed using, for example, regression analysis, to determine the propensity of an employee to depart or stay based on his satisfaction scores for the various satisfaction attributes. Alternative or additionally, a predicted propensity parameter for an ETE may be determined based on weighted combinations of satisfaction scores, which weights may be ascertained using techniques such as max-margin classifiers (e.g., SVM, Bayesian models, etc.).

The result is a data-science driven approach to model turn-over on an ETE by ETE (e.g., employee by employee or group of employees by group of employees or department by department basis). A report may then be generated to associate the ETEs (e.g., employees or departments) with turnover probability percentages and optionally contribution scores. With this report, management would be able to appreciate the turnover propensity of specific ETEs and/or average turnover propensity for the department or organization and would also appreciate their respective level of contribution and may be able to model an appropriate response using the aforementioned what-if analysis.

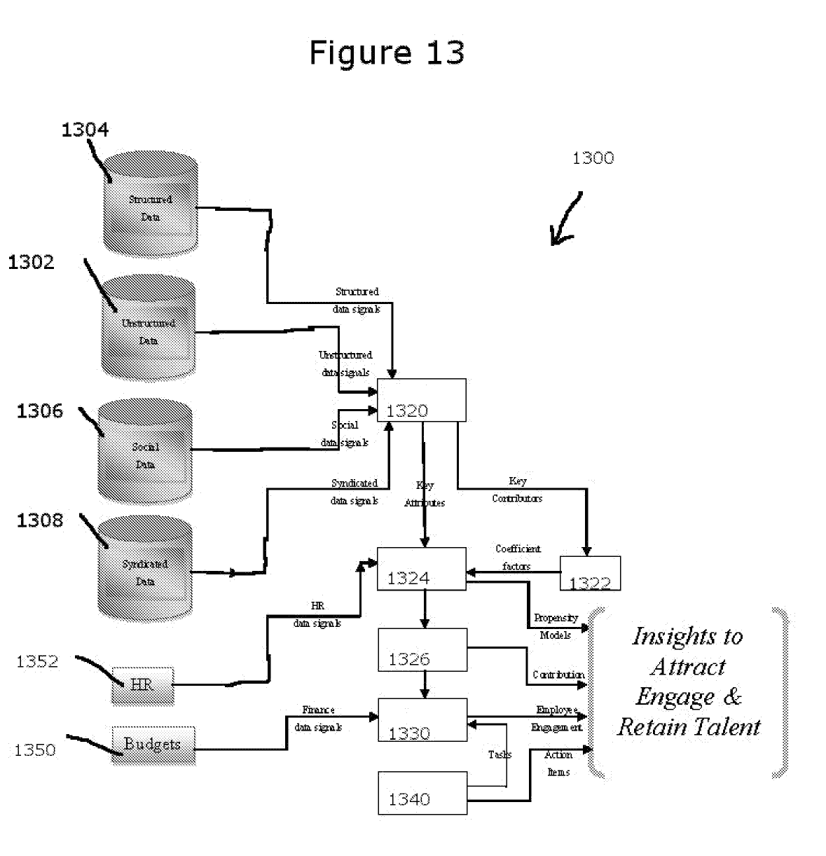

FIG. 13 shows, in accordance with an embodiment of the invention, a data flow representation 1300 of the process for determining retention (turnover propensity) and contribution (engagement) for ETE's (e.g., employee or group of employees) of an organization. The process of FIG. 13 ingests structured and more importantly unstructured data from various sources to form aggregated data. The aggregated data is then processed using natural language processing (NLP) and other techniques to ascertain attributes and contributors. These attributes can be in the form of sentiment (i.e., positive, negative, or neutral), emotions, topics (e.g., trend, hot topics, topics specified to be important to the organization). These attributes are correlated with metadata to allow the business query to be calibrated with respect to any metadata parameter (e.g., by employee, by location, by, department, by time, etc.) for relevance.

Data source 1302 is an unstructured data source, representing for example narrative data from sources internal or external to the organization. Examples include, without limitation, various write-ups by doctors or nurses or other employees of a healthcare organization, manager or employee feedback, surveys, transcripts of conversations, emails, postings in internal and external web sites and blogs, and the like. The data may be collected and digitized in unstructured data source 1302.

Data source 1304 is a structured internal data source, representing the structured data collected by the organization. Examples include, without limitation, data from HR and employee evaluation databases, employee compensation records, employee grievance databases, annual review databases, data from various enterprise resource planning and other enterprise data stores, and the like. Data source 1304 may also include external structured data. Much of this data is already digitized or can be digitized and stored in structured data source 1304.

Social data source 1306 is a data store of social media, forum, and/or blog unstructured data. Examples include, without limitation, posts in forums, blogs, or websites that pertains to the organization and/or its employees or involves discussions by or about its employees, as well as information gathered from general social media sites on the internet such as for example Facebook or LinkedIn or Twitter or Instagram.

Syndicated data source 1308 is a data store of third party data that provides raw or filtered data or processed data that may be of interest to the organization with regard to retention and/or engagement. Examples include, without limitation, news articles, published reports, private studies, private data compilations, rankings, scorings, surveys, and the like. Syndicated data source 1308 may be either structured or unstructured.

Data sources 1302-1308 are only examples and should not be construed to be limiting of the sources or types of data that can be employed by embodiments of the invention. Generally speaking, unstructured and structured data from these data sources 1302-1308 and others may be aggregated in logic and datastore block 1320.

In logic and datastore block 1320, the data is aggregated, pre-processed in preparation for analysis by natural language processing (NLP) and other data processing techniques. As the term is employed herein, natural language processing may include the use of statistical and/or machine learning and may encompass the fields of text analysis as well as other computational linguistics techniques. NLP is a well-established field and will not be further elaborated here.

The outputs of block 1320 are key attributes and key contributors. Key attributes include such things as sentiment, emotions, topics, pertaining to contribution and/or satisfaction, all of which may be calibrated to the metadata values (e.g., attributes for the employees, for specific group of employees or specific departments, etc.). Sentiment may be positive, negative, or neutral. Emotion represent the subjective representation of the intensity of the sentiment, as discussed earlier (e.g., hate, avoid, accepting, satisfied, happy, elated, ecstatic intensity gradations). Risk-related topics can be analyzed for trending topics, the top (N) topics discussed, or the topics of special interest to the business, for example.

Key contributors are the variables that have been uncovered to be deemed correlated with or likely to be the cause of the attributes discovered. These are aspects of the actual experiences or perceptions of the stakeholders that give rise to the attribute. As an example, the attribute of “compensation” may be contributed by (e.g., associated with the contributors) salary and/or stock options and/or health insurance benefits to produce satisfaction score pertaining to compensation.

Key contributors are, if desired, provided to logic block 1322 to derive coefficient factors, essentially allowing the contributors to be weighted. Examples of weights for the contribution scores have been discussed earlier in connection with FIG. 9. Similar weights can be determined for the satisfaction scores, for example.

The attributes and coefficient factors are then provided to logic and datastore block 1324, where they are processed with for example data from the employee performance rating database (1352). The attributes and coefficient factors pertaining satisfaction may then be processed to derive the propensity data or propensity models or the employees. This propensity determination has been discussed earlier in connection with FIGS. 10, 11, and 12.

The attributes and coefficient factors may also be provided to logic and datastore block 1326 wherein the ETE's contribution scores are determined from the structured and unstructured data and correlated with the ETE's satisfaction scores. This mapping results in the engagement matrix of FIG. 8, for example, and permits the organization to understand, as discussed in connection with FIG. 8, for example which segment of employees are aligned with the organization, which segment is disengaged, and which segment is highly satisfied but not contributing.

The attributes and coefficient factors pertaining to satisfaction and/or contribution may also be provided to logic and datastore block 1330 where they may be combined with compensation data, department/company budget data and other financial data (1350) to permit the type of what-if analysis discussed earlier in connection with FIG. 10. This permits the organization to understand for example the budget and/or satisfaction and/or contribution impact with various hypothetical scenarios.

Logic block 1340 represents audit/improvement data that address inefficiencies, issues, or concerns. This data may come from, for example, audit processes or may be independently proposed ideas that are derived independent of the aggregated data. The audit/improvement data may be fed into logic and datastore block 1330 to further tune the employee engagement modeling. Such action items may also be provided to interested persons and/or entities (e.g., department, line of business) for consideration to improve the organization and/or analysis in the future.

As can be appreciated from the foregoing, embodiments of the invention permit organizations and/or their consultants (e.g., HR consultant) to model, using a data science approach, the propensity of employee turn-over and the level of engagement of employees. Both unstructured and structured data from internal and external sources may be analyzed to obtain the contribution and/or satisfaction scores. Correlation between satisfaction and contribution may be made on an employee-by-employee basis or on the basis of a group of employee to ascertain which segment of the employee population is high contributing but low satisfaction, low contributing but high satisfaction, low contributing and low satisfaction, high contributing and high satisfaction, and granular stratifications in between. What-if analysis permits assessment of the impact on satisfaction, contribution and/or budget for various what-if scenarios, permitting management to take the most effective action to drive retention and/or employee contribution goals.

Embodiments of the invention, including methods and apparatuses therefor, may be used to identify groups of candidates who would be most likely to be satisfied and contributing to the goals of the organization. Thus, embodiments of the invention not only help organizations engage and manage their current employees but would also aid in recruiting the right talent on an ongoing basis. This data-science driven method (which may be implemented by but not limited to machine-learning techniques in an embodiment) allows organizations to hire and manage human talent more efficiently and with a greater degree of success.

While this invention has been described in terms of several preferred embodiments, there are alterations, permutations, and equivalents, which fall within the scope of this invention. The invention should be understood to also encompass these alterations, permutations, and equivalents. It should also be noted that there are many alternative ways of implementing the methods and apparatuses of the present invention. Although various examples are provided herein, it is intended that these examples be illustrative and not limiting with respect to the invention.

What is claimed is:

1. A computer-implemented method for obtaining employee insights from aggregated data pertaining to an organization, said aggregated data including at least unstructured data, comprising:
processing said aggregated data using natural language processing to generate a set of attributes, said set of attributes being associated with at least one of satisfaction and contribution;
processing said aggregated data using natural language processing to generate a set of contributors, said set of contributors being related to said set of attributes; and
analyzing, using said of attributes and said set of contributors, to generate a set of insights, said set of insights including at least one of a satisfaction level and a contribution level associated with an evaluation target entity (ETE) of said organization, said ETE being one or more employees of said organization.

2. The computer-implemented method of claim 1 wherein said natural language processing includes topic analysis and said set of attributes includes said set of topics.

3. The computer-implemented method of claim 1 wherein said natural language processing includes sentiment analysis and said set of attributes includes said set of sentiments.

4. The computer-implemented method of claim 1 wherein said natural language processing includes emotion analysis and said set of attributes includes said set of emotions.

5. The computer-implemented method of claim 1 wherein said analyzing also employs employee evaluation data for employees of said organization.

6. The computer-implemented method of claim 1 wherein said analyzing also employs financial data of said organization.

7. The computer-implemented method of claim 1 wherein said aggregated data comes from multiple data sources.

8. The computer-implemented method of claim 1 wherein said aggregated data includes structured data.

9. The computer-implemented method of claim 1 wherein said unstructured data includes social media data.

10. The computer-implemented method of claim 1 wherein said unstructured data includes blog data.

11. The computer-implemented method of claim 1 wherein said unstructured data includes narrative data obtained from sources internal to said organization.

12. The computer-implemented method of claim 1 wherein said set of contributors are associated with weights prior to said analyzing.

13. The computer-implemented method of claim 1 further including analyzing what-if scenarios to assess budget impact against change in at least one of a contribution level and a satisfaction level associated with said ETE.

14. A computer-implemented method for analyzing contribution and satisfaction data pertaining to employees of an organization, said analyzing being responsive to a query, comprising:
aggregating unstructured data from various data sources to form aggregated data;
processing said aggregated data using natural language processing to generate a set of attributes, said set of attributes represent at least one of a set of topics, a set of sentiments, and a set of emotions; and
processing said set of attributes to generate a set of insights, said set of insights representing at least one of a level of satisfaction and a level of contribution associated with an evaluation target entity (ETE) of said organization, said ETE being one or more employees of said organization.

15. The computer-implemented method of claim 14 wherein said natural language processing includes topic analysis and said set of attributes includes said set of topics.

16. The computer-implemented method of claim 14 wherein said natural language processing includes sentiment analysis and said set of attributes includes said set of sentiments.

17. The computer-implemented method of claim 14 wherein said natural language processing includes emotion analysis and said set of attributes includes said set of emotions.

18. The computer-implemented method of claim 14 wherein said aggregating includes aggregating structured data to form said aggregated data.

19. The computer-implemented method of claim 14 wherein said unstructured data includes social media data.

20. The computer-implemented method of claim 14 further including analyzing what-if scenarios to assess budget impact against change in at least one of a contribution level and a satisfaction level associated with said ETE.
